(19) United States
(12) Patent Application Publication
(10) Pub. No.: US 2008/0294534 A1
(43) Pub. Date: Nov. 27, 2008

(54) SYSTEM AND METHOD FOR ONLINE SHOPPING OPTIMIZATION

(76) Inventors: Jonathan H. Brown, Charleston, SC (US); John Z. Zhu, Mt. Pleasant, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 12/111,045

(22) Filed: Apr. 28, 2008

Related U.S. Application Data
(60) Provisional application No. 60/914,394, filed on Apr. 27, 2007.

(51) Int. Cl. G06Q 30/00

(52) U.S. Cl. 705/27

(57) ABSTRACT

Online shopping optimization in this context means, in general, making the optimal business decisions with regard to an online or electronic commerce purchase. The method begins with extracting buyer's demand information from buyer-specified items or a previously-configured shopping cart. It then includes a product catalog search that, when provided with the items specified or selected by the buyer, returns exact or equivalent (i.e., replacement or substitute) items. With the catalog search results, the online shopping optimization method formulates the online shopping decision-making problem into a mathematical programming model, particularly a mixed integer programming model. The method optimally decides, from the universe of vendors and items within the system: 1) from which of the various vendors to buy, 2) what identical, replacement, or substitute items to buy, 3) what package sizes of these items to buy, and 4) how many of each item to buy. To summarize, the system systematically and quantitatively makes decisions for a buyer over various cataloged items in order to maximize or minimize an objective function subject to various constraints including the buyer's demands of the desired items, the minimum order requirements imposed by the vendors on the buyer's spent monetary amount, together with other types of buyer, vendor, buyer-and-vendors interrelationship, or among-vendors interrelationship constraints. Recommended optimized shopping carts are then presented to the buyer.

### CLAIM OF PRIORITY

The present application claims the benefit of the United States provisional application filed on Apr. 27, 2007 by Brown et al. for SYSTEM AND METHOD FOR ONLINE SHOPPING OPTIMIZATION (Ser. No. 60/914,394), the entire disclosure of which is incorporated by reference herein as if set forth verbatim.

### FIELD OF THE INVENTION

The present invention relates generally to electronic commerce. More particularly, the present invention relates to a system and method constructed to optimize the contents of a buyer's shopping cart based on a number of factors.

### BACKGROUND OF THE INVENTION

A need for online shopping optimization arises in a number of online shopping areas such as consumer shopping, organizational procurement, supplier, manufacture, and surplus seller. For example, faced with a large number of available substitute products from many different vendor catalogs, a buyer can have an overwhelmingly large number of different ways to select products to meet the buyer's demand. The different ways to select products lead to different shopping costs. When attempting to minimize the shopping cost manually, the buyer will need to consider not only these many plausible ways to compose the shopping cart but also additional constraints. One particular type of constraint is called the minimum order requirement often imposed by vendors. This minimum order requirement of a given vendor states that the total monetary amount spent on a purchase from the vendor has to be greater or equal to a fixed monetary amount entitled the “minimum order” specified by the vendor. Different vendors often have different minimum order requirements. This requirement implies that a buyer selecting a competitively-priced product is prevented from purchasing the product unless the buyer's combined purchase from the same vendor exceeds the minimum order.

These shopping decisions can typically be subject to other constraints, such as a budget, the number of distinct vendors involved in the purchase, and the delivery date. They are also subject to vendor-introduced factors such as discounts, price breaks (bulk prices), and special incentive deals.

### SUMMARY OF THE INVENTION

The present invention recognizes and addresses the foregoing considerations, and others, of prior art construction and methods.

In one aspect, the present invention provides a system and method for optimizing online shopping decisions on buying multiple products from multiple online vendors having respective product catalogs, such as which products should be purchased from which vendors having what package sizes and what quantity to buy, to obtain a satisfactory value of an objective function reflecting the shopping decisions subject to a plurality of constraints, such as vendor, buyer, between-buyer-and-vendors interrelationship, and among vendors interrelationship constraints by defining, in a computing device, a catalog of products, wherein the catalog corresponds to each vendor and is configured to offer product specification information and a corresponding price information; defining, in the computing device, a catalog search for returning exact or equivalent products when called with input product-related parameters; constructing, in the computing device, a mathematical programming modeling method for modeling the online shopping decision optimizing problem; and constructing, in the computing device, an optimization solution method for solving the online shopping decision optimization problem.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIGS. 1 and 2 are schematic representations of a system for online shopping optimization in accordance with an embodiment of the present invention; and

FIG. 3 is a flowchart of a method for optimizing online shopping in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

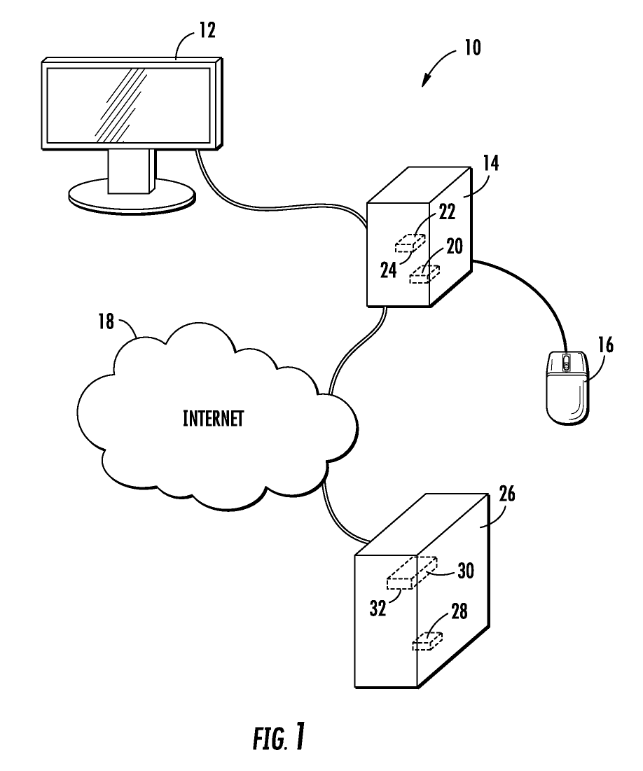

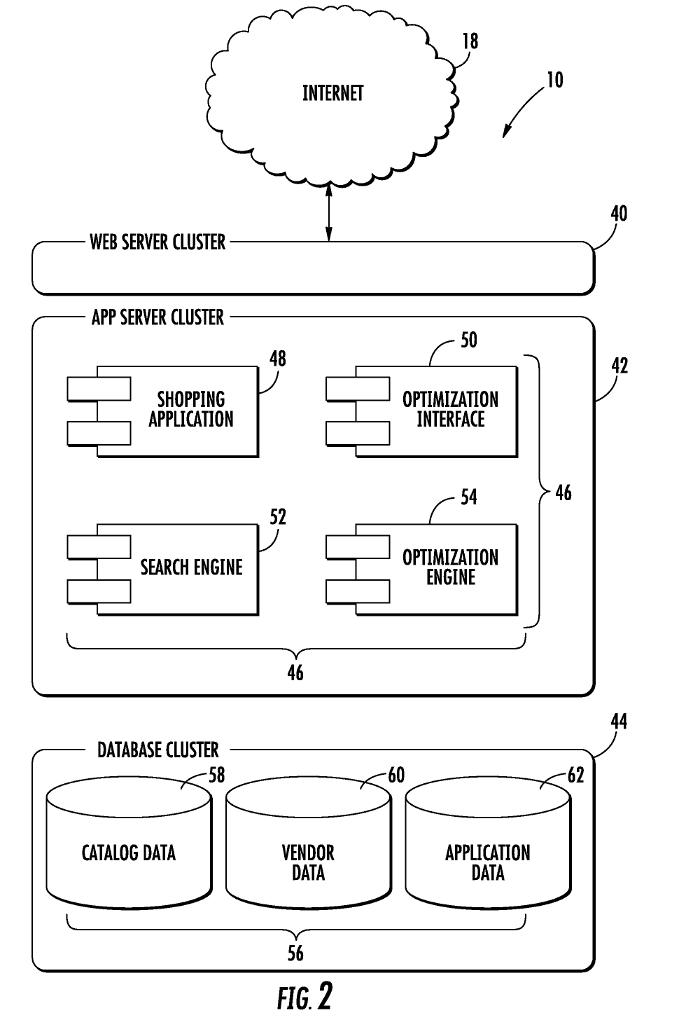

FIGS. 1 and 2 illustrate a system 10 for online shopping optimization in accordance with an embodiment of the present invention. Referring to FIG. 1, system 10 comprises a display 12, a computer 14, and an input device, such as a mouse 16 or a keyboard. Computer 14 may be connected to a local or distributed network, such as the Internet 18, and comprises a processing device 20 and computer readable memory 22, which may include at least one database 24. It should be understood that computer readable memory can be, for example, cache, random access memory, a hard drive, a flash drive, a CD-ROM, a DVD, or a combination thereof. System 10 may also include additional computers connected to the Internet 18, such as server 26, which includes its own processing device 28 and computer readable memory 30 that may include one or more additional databases 32. In the presently-described embodiment, a program or program code is stored on computer readable memory 22 such that, when executed by processing device 20, performs the processes described below. In another embodiment, a portion of the program or program code is stored on computer readable memory of one or more additional computers connected to the network, such as computer 18 and/or server 26.

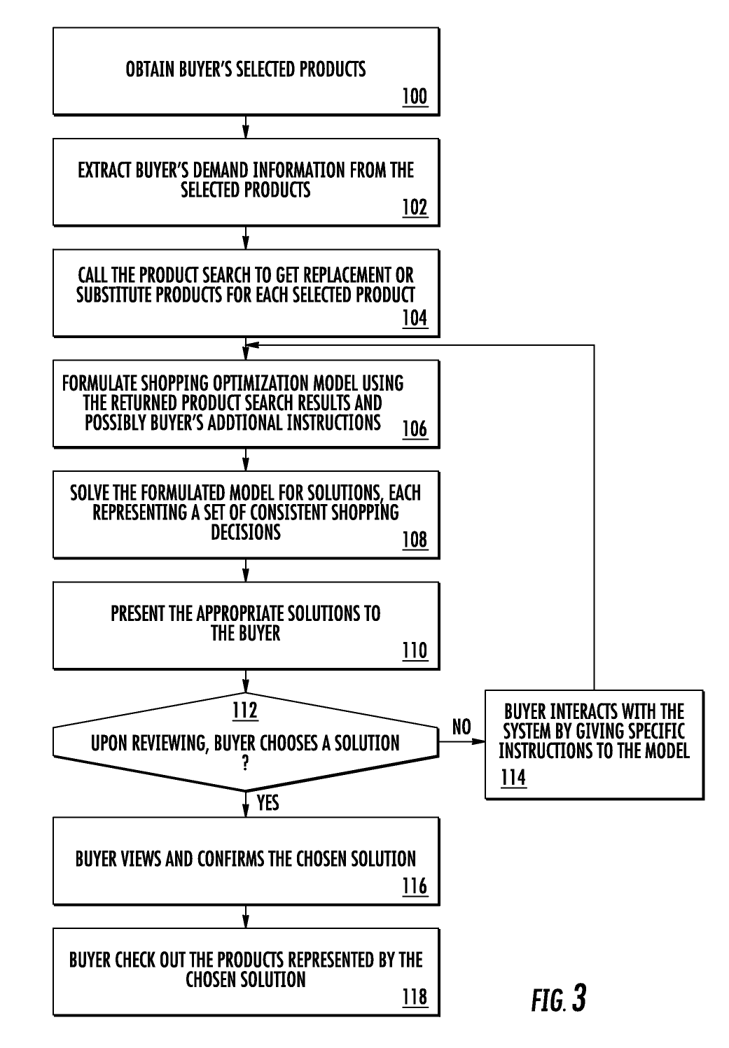

Referring to FIG. 2, system 10 comprises a web server cluster 40 operatively connected to an application server cluster 42. Both clusters 40 and 42 are operatively connected to database cluster 44. Application server cluster 42 may comprise one or more modules 46 to perform the method described below with respect to FIG. 3, such as a shopping application 48, an optimization interface 50, a search engine 52, and an optimization engine 54. Database cluster 44 may comprise one or more databases 56, such as catalog database 58, vendor database 58, and application database 60. Modules 46 and databases 56 may be located within one processing device, such as computer 14 (FIG. 1), or may be distributed over more than one processing devices, such as computer 14 and server 26 (FIG. 1).

FIG. 3 illustrates a method for optimally conducting online shopping activities, and, more particularly, for online shopping optimization. Online shopping optimization in this context means the specific ways of making the optimal business decisions when conducting an online purchase in electronic commerce. These optimal business decisions imply an optimal value of an objective function. An example of such an objective function is the mathematical expression of the total cost of all the items in a buyer's shopping cart. Thus, one optimal business decision may be to minimize the mathematical expression of the total cost of all the items in a shopping cart, thereby minimizing the total cost of the items. Another optimal business decision may be to minimize the mathematical expression of the estimated amount of time to receive the items or of the shipping costs.

One method of representing such online shopping optimization problems is known as a mixed integer programming model. Such a model includes a number of linear relationships, set forth in matrix format with integer constraints on the decision variables, representing quantitatively the relationships among decisions (including from which vendors to purchase and how many items to buy), constraints, and results that are implied by the decisions of an online shopping experience. In these linear relationships, there is provided the sum of constant coefficients multiplied by an unlimited number of buying decision values. While it is contemplated that some online shopping optimization problems may not be represented by linear relationships, but may involve higher powers or other nonlinear expression of decision variables, the presently-described embodiment of the present invention is directed to the class of online shopping optimization problems capable of being identified as linear models. In order to deal with the integer decision variable constraints, the most widely-used branch and bound method for solving integer programs is used. In the branch and bound method, subproblems are created by restricting the range of the integer variables, resulting in subproblems with fewer or no integer variable constraints. These subproblems become children of the root search node. The algorithm is applied recursively to the subproblems, generating a tree of subproblems. A lower bound for a minimization problem is provided by the linear programming relaxation to the problem: keep the objective function and all constraints, but relax the integrality restrictions to derive a linear program. If the optimal solution to a relaxed problem is an integer, it is an optimal solution to the subproblem, and the value can be used to terminate searches of subproblems whose lower bound is higher. Linear programming should be understood by those in the art and is, therefore, not described in more detail. An optimum solution to a linear programming problem can be obtained by use of the Simplex algorithm developed by George Dantzig in 1947, for example, or by the more recent Karmarkar algorithm, as disclosed in U.S. U.S. Pat. No. 4,924,386 of Freedman et al., the entirety of which is incorporated by reference herein as if set forth verbatim.

In operation and referring to FIGS. 2 and 3, a buyer visits a website hosted by web server cluster 40. Web server cluster 40 may include one or more processing devices, such as computer 14 and server 26. The website is operatively connected to an application server cluster 42, which may include a number of modules, such as shopping application 48, optimization interface 50, search engine 52, and optimization engine 54. The website may be maintained by one or more vendors or a third party that retrieves information from one or more vendors. The buyer uses the website to search for and select items offered by the vendors, which are maintained in database cluster 44. That is, the buyer may initiate a shopping session by performing a search for the desired items through the use of search engine 52, which searches the information stored in databases 56. The search may be a keyword or parametric search. System 10 may be configured to allow the buyer to either search for and/or select specific items or allow the buyer to enter information descriptive of a general product the buyer desires to purchase, such as “120 pencils,” and not search for and select a specific product. Shopping application 48 is configured to create a virtual shopping cart, which may be stored in application database 62, in order to store data representative of the selected items and corresponding information, such as the desired quantities.

At step 100, information related to the products selected by the buyer is transmitted to system 10 once the buyer has selected at least a portion of the items the buyer desires to purchase. Alternatively, data representative of the entire virtual shopping cart is transmitted to system 10. A module or application, such as optimization interface 50, extracts and stores the information regarding the buyer's desired products, such as characteristics identifying the selected items and the desired quantities, at step 102. For example, if the buyer has selected 100 boxes, each containing 12.7 mm mechanical pencils manufactured by Company A from the catalog of Vendor 1, optimization interface 50 extracts information indicating that the 1200 pencils desired by the buyer are mechanical, eraser-tipped, and use 0.7 mm, #2 lead. At step 104, system 10 searches for identical, replacement, or substitute products for each selected item based on the information extracted at step 102. For example, search engine 52 may be used to conduct a search for items identical to the selected items offered by vendors other than Vendor 1. Similarly, search engine 52 or another search engine may be used to conduct a parametric search in order to find mechanical, eraser-tipped lead pencils using 0.7 mm, #2 lead, manufactured by companies other than Company A and/or supplied by vendors other than Vendor 1.

At step 106, system 10 formulates a shopping optimization model using the information received at steps 102 and 104 as described in more detail below. Additional information available to shopping application 48 may also be extracted for use by the optimization process. For example, the buyer's profile stored in application database 62 and the vendor's profile stored in vendor database 60 may provide system 10 with additional criteria, constraints, or information regarding the desired items at step 106 that may be used to form the shopping optimization model. For instance, the buyer's profile may provide system 10 with an additional constraint that the buyer does not want to purchase any items from a specific vendor. Likewise, the profile for a specific vendor may include information representative of the fact that the vendor will waive any shipping cost if the total purchase amount from the vendor is greater than a specific amount or that the vendor enforces a minimum order requirement.

System 10 creates the mathematical formulation for capturing all possible ways of purchasing the items desired by the buyer based on the data maintained by database cluster 44. Optimization engine 54 is configured to solve this mathematical formulation in order to determine the optimal solution, which the buyer desires to obtain. For example, the mathematical formulation includes all possible purchasing solutions for 1200 mechanical, eraser-tipped, 0.7 mm, #2 lead pencils desired by the buyer. System 10 forms matrices for the mathematical formulation by appropriately arranging the coefficients in the mathematical equations as described below.

Each desired outcome or objective function may be expressed as a linear function. For example, where the buyer wishes to minimize the total cost of all desired items i that may be purchased from all vendors j, the solution may be expressed as

$$min {\sum }_{i , j} {c}_{i , j} {x}_{i , j} \qquad Eq . 1$$

where c_{i,j} is the unit cost of each desired item i charged by vendor j, and x_{i,j} is the number of items i to be purchased from vendor j. This linear function determines the minimum total cost of the items to be purchased from the vendors. The result identifies the total monetary amount for purchasing all the products identified by the buyer from different vendors. It should be understood that Equation 1 provides the optimal solution to the mathematical programming model, which minimizes the total dollar amount for purchasing the products. It is possible, however, to configure a number of different objective functions to obtain different objectives or goals. For example, an objective function may be provided to minimize either delivery time or the number of vendors involved. It should be understood that an objection function may be provided to minimize a weighted combination or average of the objectives set forth above or other objectives or goals. By way of another example, the mathematical programming model may incorporate an objective function that provides a solution that maximizes product or vendor ratings, if the buyer desires to purchase items that are highly rated or to purchase items from vendors that are highly rated.

Constraints and criteria for the model may also be expressed as linear functions. For example, vendors who offer the desired items or items comparable to the desired items may only sell the items in a package, which contains a specific number of the individual desired items. This adds a constraint to the mathematical programming model described above, that may be referred to as a “demand constraint.” In order to ensure that the total number of desired items that are sold by the package are acquired, the demand constraint may be expressed as

$${\sum }_{j} {s}_{i , j} {x}_{i , j} \geq {d}_{i} for all i \qquad Eq . 2$$

where s_{i,j} is the number of item i in a package sold by vendor j, and dᵢ is the buyer's demand for item i. This constraint as expressed as a linear function requires that the number of specific items in all the packages bought from a specific vendor is equal to or greater than the number desired by the buyer.

As set forth above, every constraint may be expressed as a linear function. For example, the minimum order requirement described above may be expressed as the linear function

$${\sum }_{i} {c}_{i , j} {x}_{i , j} \geq {m}_{j} for all j \qquad Eq . 3$$

where mⱼ is the minimum order requirement for each vendor j.

Another constraint, which may be referred to as a “vendor choice constraint,” may be incorporated into the mathematical programming model to consider the buyer's purchasing preference. For example, the buyer may chose not to purchase items from a specific vendor. This vendor choice constraint may be expressed as the linear function

$${\sum }_{i} {x}_{i , j} \leq {Mz}_{j} for all j \qquad Eq . 4$$

where zⱼ is a binary integer variable representing whether each vendor j should be chosen to purchase products from, and M is a very large integer. As a result, the product of Mzⱼ will either be a large value or zero, depending upon whether the value of decision variable zⱼ is 1 or 0, respectively. Therefore, Equation 4 effectively provides no constraint to any x_{i,j} for all i when the value of zⱼ is 1. The value of x_{i,j} is 0, however, for all i when the value of zⱼ is 0, thereby essentially removing outcomes that include vendor j from the programming model when vendor j is not be considered.

Furthermore, constraints subject to a condition may also be added to the programming model as linear functions. For example, vendors may offer free shipping on orders equal to or greater than a predefined dollar amount. With regard to the example described above with reference to Equation 1, free shipping for qualifying orders offered by at least one of the vendors will have an impact on the desired outcome; i.e., the minimum total cost for the desired item, such that the corresponding linear objective function becomes

$$min {\sum }_{i , j} {c}_{i , j} {x}_{i , j} + {\sum }_{j} {y}_{j} \qquad Eq . 5$$

where yⱼ is the amount of the shipping fee charged by vendor j. Because a condition must be met to charge the shipping fee, however, the following conditional constraints are added:

$$\begin{matrix}{\sum }_{i} {c}_{i , j} {x}_{i , j} = {t}_{j} for all j & Eq . 6 \\ {t}_{j} \geq {l}_{j} ⇒ {y}_{j} = 0 for all j & Eq . 7 \\ {t}_{j} < {l}_{j} ⇒ {y}_{j} = {h}_{j} for all j & Eq . 8\end{matrix}$$

where tⱼ is the total cost of all the items purchased from vendor j, and lⱼ is the minimum amount that must be met for shipping to be free. That is, if the total amount (t) to be paid to a vendor j is equal to or greater than a predefined amount (l), then the shipping fee (y) is zero, as set forth in Equation 7. On the other hand, if the total amount to be paid to a vendor is less than the predefined amount, then a specific shipping fee (h) for vendor j is added in Equation 5, and considered when determining the optimal solution.

Once the problem to be solved and the corresponding constraints have been defined as linear functions, the linear functions are transmitted as inputs to a solution or solver engine, such as optimizer engine 54, as data matrices in order to determine the optimal solution, at step 108. For example, system 10 provides Equations 2 through 8 above as inputs to optimizer engine 54, which generates optimal solutions that include the solution values of x_{i,j}, zⱼ, and yⱼ for all i and j. In the present embodiment, optimizer engine 54 is a mixed integer programming solution engine, such as OPL or CPLEX solver products offered by ILOG, Inc. located in Sunnyvale, Calif. and Gentilly, France. At step 110, system 10 then presents one or more optimal solutions to the buyer as optimized shopping carts along with the buyer's original shopping cart. In the preferred embodiment, system 10 presents the three most optimal solutions. System 10 allows the buyer to compare the different solutions and to analyze the processes performed by the optimization. Thus, the buyer possesses the ultimate determination of which cart is the most appropriate. The resulting shopping carts may be ranked by various characteristics, such as by information representative of the desired objective of the mathematical programming model, including the total cost of each cart. If the buyer decides to select a solution from those presented, the buyer confirms the selected solution at step 116, and proceeds to pay for the selected solution in a “check-out” process at step 118. This includes allowing the buyer to initiate a financial transaction to purchase the items identified in the chosen solution from the vendors identified in the chosen solution. If the buyer does not select a solution at step 112, the buyer interacts with the system by giving instructions to the model at step 114. This may include searching for additional items, providing additional constraints to the programming model, or selecting a different problem to be solved. Process flow returns to step 106 at this point and continues as described above.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A method for optimizing online shopping decisions on buying a plurality of items from a plurality of online vendors each having a respective product catalog database to obtain a satisfactory value of an objective function reflecting said shopping decisions subject to a plurality of constraints, said method comprising the following steps:
defining, in a computing device, a catalog database of said items, wherein said catalog database corresponds to a respective one of said vendors, said catalog database being configured to offer product specification information and price information for each of said items;
defining, in said computing device, a catalog search for returning said items selected from the group comprising at least two of exact items, equivalent items, replacement items, and substitute items when called with input product-related parameters;
constructing, in said computing device, a mathematical programming modeling method for modeling said online shopping decision optimizing problem; and
constructing, in said computing device, an optimization solution method for solving said online shopping decision optimization problem.
